(19) United States
(12) Patent Application Publication
(10) Pub. No.: US 2020/0115270 A1
(43) Pub. Date: Apr. 16, 2020

(54) FIBER PREFORM, OPTICAL FIBER AND METHODS FOR FORMING THE SAME

(71) Applicant: Nanyang Technological University, Singapore (SG)

(72) Inventors: Seongwoo Yoo, Singapore (SG); Xiaosheng Huang, Singapore (SG)

(21) Appl. No.: 16/493,122

(22) PCT Filed: Mar. 2, 2018
(86) PCT No.: PCT/SG2018/050097

§ 371 Date: Sep. 11, 2019

(30) Foreign Application Priority Data
Mar. 14, 2017 (SG) 10201702032P

(51) Int. Cl. C03B 37/012; C03B 37/027; G02B 6/032; G02B 6/02

(52) U.S. Cl. CPC C03B 37/0122; C03B 37/02781; G02B 6/032; C03B 2205/08; C03B 2203/16; C03B 2203/23; C03B 2203/42; G02B 6/02361

(57) ABSTRACT

According to embodiments of the present invention, a fiber preform or an optical fiber is provided. The fiber preform or the optical fiber includes a core region, and a cladding arrangement comprising a first cladding region comprising a plurality of rods entirely surrounding the core region, and a second cladding region in between the core region and the first cladding region, the second cladding region comprising a plurality of tubes, wherein a plurality of splits are defined in the second cladding region. According to further embodiments of the present invention, a method for forming a fiber preform and a method for forming an optical fiber are also provided.

### CROSS-REFERENCE TO RELATED APPLICATION

This application claims the benefit of priority of Singapore patent application No. 10201702032P, filed 14 Mar. 2017, the content of it being hereby incorporated by reference in its entirety for all purposes.

### TECHNICAL FIELD

Various embodiments relate to a fiber preform, an optical fiber, a method for forming a fiber preform and a method for forming an optical fiber.

### BACKGROUND

Hollow core photonic crystal fibers (HC-PCFs), due to their characteristics, have promising applications in high power beam delivery, chemical sensing, gas-based nonlinear optics, and generation of supercontinuum. According to the waveguide mechanism, HC-PCFs are typically classified into two kinds, where light guidance via the air core in the HC-PCFs is typically achieved by utilizing a two-dimensional photonic bandgap or antiresonant reflection (or inhibited coupling). The former one is called hollow core photonic bandgap fibers (HC-PBGFs), while the latter is commonly named hollow core anti-resonant fibers (HAFs).

The first antiresonant fiber was experimentally demonstrated as a Kagome Fiber (KF) which was constituted from a multiple layers of air holes running down the fiber. It was proven that the optical properties of the KF largely depended on the first air cladding layer surrounding the air core. Subsequently, a simplified antiresonant structure with one air cladding layer has been widely investigated as a hollow core antiresonant fiber or an inhibited coupling fiber where the inhibited coupling model offers more precise description of the fiber guidance. The simplified structure features a negative core curvature, a non-touching core boundary and one tube cladding layer, thus often being named as a Tube Lattice Fiber (TLF). The negative curvature is found to enhance the coupling inhibition between the core and cladding modes while the non-touching core boundary helps to reduce loss caused by the Fano-resonance. Moreover, the simple one ring cladding is proven sufficient to offer efficient light guidance. Consequently, the first ring has been the emphasis of a TLF design.

Unlike the HC-PBGFs whose transmission loss is dominated by the surface scattering loss, the dominant loss in HAFs is the confinement loss (CL). CL of the hollow core fibers is highly related to the value of r/λ, where r is the fiber core radius, and λ is the (transmission) wavelength. As r/λ gets smaller, the attenuation of modes is quickly increased.

Recently, a record transmission loss of 7.7 dB/km at 750 nm in a TLF has been demonstrated, but the transmission loss was compromised as wavelength increases, e.g. 70 dB/km at 1500 nm. This is attributed to the characteristics of the TLF where a confinement loss (CL) is associated with the value of r/λ, or D/λ, where D is the core diameter. As the transmission window moves to a longer wavelength or the core size is reduced, the CL instantly increases. Hence, a large core is a typical feature in the TLF. Although the large core certainly helps to reduce the CL, it can sometimes contradict other requirements. For instance, a small core can increase pump light intensity and ameliorate high power requirement to overcome a threshold in gas-filled TLF applications. Thus, a small core TLF without compromising the CL could be a next important step to advance the gas-filled TLF technology.

Simplified hollow core anti-resonant fibers (SHAFs), which are one of the more popular hollow core fibers in recent years, are limited by the relationship between CL and r/λ. FIG. 1A shows an example of a simplified hollow core anti-resonant fiber (SHAF) 190a with an outer cladding 191a, a cladding region 192a, and a core 193a. To achieve a relatively low loss, SHAFs are commonly fabricated to satisfy r/λ greater than 12. Hence, a small core radius is unavailable in SHAFs; otherwise the confinement loss will get much higher.

To determine the performance of a hollow core fiber in a gas light interaction system, a figure of merit, fₒₘ, in the form of fₒₘ=(λ/πr²α) has been proposed, where r is the fiber core radius, and λ is the wavelength, and α is the exponential attenuation rate of the intensity. The larger the value of fₒₘ, the better performance of the fiber. Hence, the performance of SHAFs is limited because the small core (i.e., small r value) is unavailable.

There is another type of hollow core fiber, which is the Kagome fiber 190b as shown in FIG. 1B, which has a continuous core cladding boundary 194b between a core 193b and a cladding region 192b, as well as many vertices 195b in the cladding 192b and also with the outer cladding 191b. The continuous core cladding boundary 194b can cause core shape deformation during processing progress and the vertices 195b in the cladding introduce extra loss due to Fano-resonance.

In view of the above, a hollow core fiber design known as a hollow core anti-resonant fibers with split cladding (SCF) 190c as shown in FIG. 1C was proposed to address the drawbacks of SHAFs and KFs. The split cladding fiber (SCF) 190c has an outer cladding 191c, a core 193c, and a cladding region 192c with splits (one split is represented by 196c). The confinement loss of the SCF 190c grows slower than the SHAF 190a as the value of r/λ increases. As a result, the SCF 190c performs better than the SHAF 190a in gas light interaction systems. Due to the split cladding structure 192c, the SCF 190c has few vertices 195c in the cladding 192c. Hence, the loss caused by Fano-resonance is negligible.

However, a SCF with a uniform structure has not been obtained since it was first proposed. This is because the precise pressure control is required to maintain the split cladding structure as well as a uniform core size.

### SUMMARY

The invention is defined in the independent claims. Further embodiments of the invention are defined in the dependent claims.

According to an embodiment, a fiber preform is provided. The fiber preform may include a core region, and a cladding arrangement including a first cladding region having a plurality of rods entirely surrounding the core region, and a second cladding region in between the core region and the first cladding region, the second cladding region having a plurality of tubes, wherein a plurality of splits are defined in the second cladding region.

According to an embodiment, an optical fiber is provided. The optical fiber may include a core region, and a cladding arrangement including a first cladding region having a plurality of rods entirely surrounding the core region, and a second cladding region in between the core region and the first cladding region, the second cladding region having a plurality of tubes, wherein a plurality of splits are defined in the second cladding region.

According to an embodiment, a method for forming a fiber preform is provided. The method may include arranging a plurality of rods to entirely surround a core region of the fiber preform, the plurality of rods defining a first cladding region of the fiber preform, and arranging a plurality of tubes in between the core region and the first cladding region, the plurality of tubes defining a second cladding region of the fiber preform, wherein a plurality of splits are defined in the second cladding region.

According to an embodiment, a method for forming an optical fiber is provided. The method may include drawing the fiber preform as described herein into the optical fiber.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIGS. 1A-1C show schematic cross-sectional views respectively of a simplified hollow core anti-resonant fiber (SHAF), a Kagome fiber (KF), and a hollow core fiber with split cladding (SCF) of prior art. White areas correspond to air while black areas and lines are silica.

FIG. 2A shows a schematic cross-sectional view of a fiber preform, according to various embodiments.

FIG. 2B shows a schematic cross-sectional view of an optical fiber, according to various embodiments.

FIG. 2C shows a flow chart illustrating a method for forming a fiber preform, according to various embodiments.

FIG. 2D shows a flow chart illustrating a method for forming an optical fiber, according to various embodiments.

FIG. 3A shows a schematic cross-sectional view of a preform, according to various embodiments.

FIG. 3B shows a schematic cross-sectional view of a preform of a comparative example.

FIG. 4A shows a scanning electron microscope image of a cross-sectional view of a cane of various embodiments, while FIG. 4B show a microscopic image of a cross-sectional view of the cane of FIG. 4A after being sealed using a UV glue.

FIG. 5A shows a microscopic image of a cross-sectional view of a split cladding fiber (SCF) fabricated using the method of various embodiments, while FIG. 5B shows a near field mode image at the end of a 1-meter long fiber with the structure shown in FIG. 5A when illuminated by a 1064 nm light source.

FIG. 5C shows a microscopic image of a cross-sectional view of a split cladding fiber (SCF) with a one ring structure fabricated using the method of various embodiments.

FIGS. 6A and 6B show microscopic images of cross-sectional views of split cladding fibers (SCFs) of various embodiments.

FIG. 7A shows a schematic view of the setup used to measure the transmission loss of the fundamental mode, based on the cutback method.

FIG. 7B shows plots of simulated and measured loss of different fibers of various embodiments and loss level at different D/A values.

FIG. 8A shows a schematic view of the setup for bending loss measurement.

FIGS. 8B and 8C show scanning electron microscopic images of cross-sectional views of split cladding fibers (SCFs) of various embodiments.

FIG. 9 shows a plot of the bending loss of the fiber of FIG. 8B at different bending diameters at a wavelength of about 1200 nm Region I: insignificant bending loss, region II: bending loss increases exponentially, region III: bending loss oscillates.

FIGS. 10A and 10B show plots of measured bending losses for the fibers of FIGS. 8B and 8C respectively at different bending directions. FIG. 10C shows a plot illustrating the relationship between the 3-dB diameter and the gap width (or azimuthal separation of cladding).

FIG. 11A shows plots of simulated confinement loss of the fundamental mode, and simulated refractive index of the fundamental mode, while FIG. 11B shows the airy cladding mode corresponding to the fiber structures shown.

FIG. 12A shows a schematic side view of a preform structure, according to various embodiments. FIG. 12B shows a schematic cross-sectional view of parts (A) of the preform of FIG. 12A, while FIG. 12C shows a schematic cross-sectional view of part (B) of the preform of FIG. 12A.

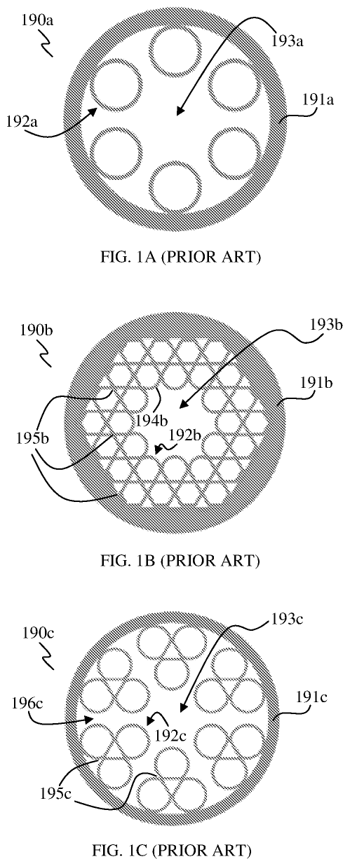

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Various embodiments may provide one or more optical fibers and method of fabricating the same. For example, various embodiments may provide a fabrication method which may fabricate a split cladding fiber (SCF) with a uniform structure.

Various embodiments may also provide a fiber design that may address or mitigate the contradiction between core size, and confinement loss, as well as with other requirements such as pump light intensity, and high power, as described above. Various embodiments may provide a two-layer TLF (2TLF) with consideration of the role of the second cladding layer on confinement loss (CL) reduction. Unlike a one-layer TLF (1TLF), the 2TLF may benefit from the presence of the second layer to suppress the CL even in a small core structure. Results of theoretical and experimental comparison of the transmission loss of the 1TLF and the 2TLF designs over several transmission bands confirm the role of the second ring, as will be described further below. Moreover, the second ring may also improve the bending loss of the fiber. A small capillary hole size may suppress the bending loss, but the small hole may also increase the CL, hence compensating the already improved bending loss from the small hole. The 2TLF design of various embodiments may resolve this contradiction. The dependence of the bending loss on the hole size is also experimentally demonstrated, as will be described below. Consequently, 2TLF may fulfil the contradicting requirements of a small core, low bending loss and low transmission loss. In view of the above, various embodiments may provide a design route with potential for gas-filled TLF applications and/or easier fiber handling.

As will be described below, determination may be made on the function of a second cladding layer in hollow core tube lattice fibers. Modes attenuation of a tube lattice fiber (TLF) is generally characterized by D/λ, where D is the core diameter and λ is the wavelength. Hence, the TLF may be structured with a large core to ensure a low attenuation loss. A small core, on the other hand, facilitates gas-filled TLF applications, but at the expense of increased mode attenuation. As will be described below, adding a second cladding layer to a one-layer TLF (1TLF) may address or resolve the contradicting requirements. The mode attenuation of TLF with two cladding layers (2TLF) may be less influenced by the D/λ value as compared to 1TLF, thus potentially realizing a low loss small core TLF. Furthermore, adding the second layer also provides an effect on the bending performance With a determined core size, D, a 1TLF with a smaller capillary hole size, d, may experience less bending loss. However, the reduced d may increase the confinement loss that counteracts the bending loss improvement. This confliction is substantially alleviated in 2TLF as a result of the second cladding layer. Theoretical investigations and experimental demonstrations presented herein show the role of the second cladding ring in improving the performances of the TLF.

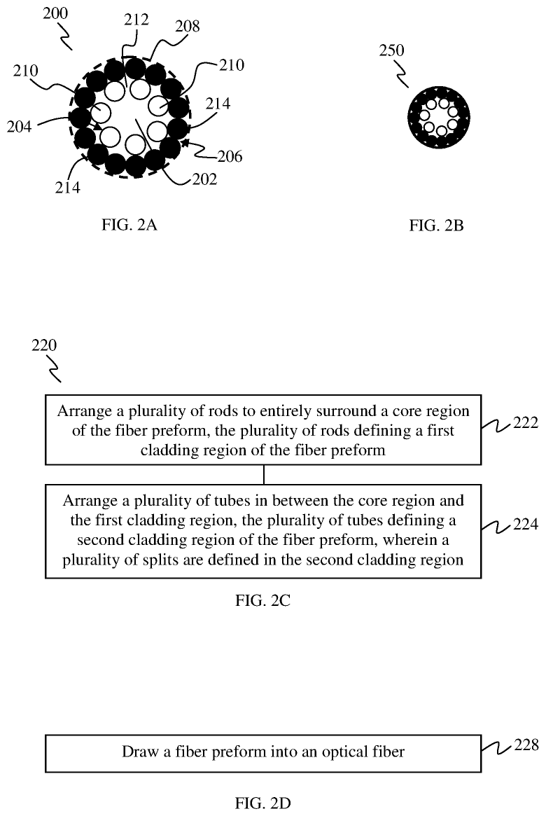

FIG. 2A shows a schematic cross-sectional view of a fiber preform 200, according to various embodiments. The fiber preform 200 includes a core region 202, and a cladding arrangement including a first cladding region 206 having a plurality of rods (shown as solid circles, where two rods are represented by 214) entirely surrounding the core region 202, and a second cladding region 204 in between the core region 202 and the first cladding region 206, the second cladding region 204 having a plurality of tubes (shown as open circles, where two tubes are represented by 210), wherein a plurality of splits (e.g., one split is shown represented by 212) are defined in the second cladding region 204. As described, the preform 200 may be formed by stacking a plurality of tubes 210 and rods 214.

In other words, a fiber preform 200 may be provided. The fiber preform 200 may include a core region 202 (or simply a core), and a cladding arrangement or structure around or surrounding the core region 202. The core region 202, as may be appreciated, means a region where light, or at least a substantial portion or majority portion of the light, may travel or propagate. The core region 202 may be centrally located within the preform 200. The core region 202 may be a hollow or air region, meaning that the preform 200 may have a hollow core.

The cladding arrangement may have two (distinct) regions: first and second cladding regions 204, 206. The cladding arrangement may further include an overcladding (shown as a dashed circle 208), which is the outermost cladding layer or jacket.

The first cladding region 206 may include a plurality of rods 214 that surround or enclose entirely the core region 202. In this way, the plurality of rods 214 may form a ring around the entire circumference of the core region 202. In other words, the plurality of rods 214 may form a full ring around the core region 202. The plurality of rods 214 may also entirely surround the second cladding region 204. As may be appreciated, the first cladding region 206 may be a rod cladding region. It should be appreciated that the first cladding region 206 may include one or more structures other than the rods 214.

The second cladding region 204 may be located or arranged sandwiched between the core region 202 and the first cladding region 206, where the second cladding region 204 may include a plurality of tubes (or capillaries) 210. The second cladding region 204 may surround the core region 202. In this way, the plurality of tubes 210 may form a ring around the circumference of the core region 202. As may be appreciated, the second cladding region 204 may be a capillary cladding region. It should be appreciated that the second cladding region 204 may include one or more structures other than the tubes 210. The plurality of tubes (or all the tubes) 210 may have the same wall thickness.

In the context of various embodiments, a “ring” may be of any shape, including, but not limited to, a circle, an ellipse, a square or a rectangle.

A plurality of splits 212 may be defined in the second cladding region 204. As a result, a split (capillary) cladding structure may be provided. Each split or a respective split 212 may extend in a direction from the core region 202 to the first cladding region 206 (or conversely from the first cladding region 206 to the core region 202). Each split or a respective split 212 may refer to a separation void (or gap) or a continuous void (or gap) (intentionally) defined in the second cladding region 204.

The plurality of splits 212 may be defined between adjacent tubes of the plurality of tubes 210. As a result of the splits 212, adjacent tubes 210 may be completely separated or spaced apart from each other. Each split or a respective split 212 may refer to a void between adjacent tubes 210 to space apart the adjacent tubes 210, rather than referring to the interstitial sites or spaces between the adjacent tubes 210. This may mean that there may be spacings in between adjacent tubes of the plurality of tubes 210, meaning that one or more tubes 210 may be spaced apart from one or more other tubes 210.

As described above, the second cladding region 204 may be proximal to the core region 202 while the first cladding region 206 may be distal to the core region 202. This means that, starting from the inner portion of the preform 200 and extending outwardly, is the core region 202, followed by the second cladding region 204, and then the first cladding region 206. Accordingly, the second cladding region 204 may be an inner cladding region while the first cladding region 206 may be an outer cladding region.

In various embodiments, the cladding arrangement may have a (effective) refractive index that is different from that of the core region 202. The first cladding region 206 and the second cladding region 204 may have the same or different (effective) refractive indices.

In the context of various embodiments, the plurality of rods 214 may be elongate rods. Each rod or a respective rod 214 may be sealed or close-ended at the two (opposite) ends. Each rod or a respective rod 214 may be a (completely) solid rod. This may mean that each rod or a respective rod 214 may not be hollow.

In the context of various embodiments, each rod or a respective rod 214 may be of any shape and/or size (or cross-section dimension or diameter). As a non-limiting example, each rod or a respective rod 214 may have a circular cross-sectional shape. However, it should be appreciated that other shapes may be possible, including but not limited to, ellipse, square or rectangle. It should be appreciated that the plurality of rods 214 may have the same or different shapes and/or sizes.

In the context of various embodiments, the plurality of tubes 210 may be elongate tubes. Each tube or a respective tube 210 may be unsealed or open-ended at the two (opposite) ends. Each tube or a respective tube 210 may be a capillary or capillary tube. Each tube or a respective tube 210 may be hollow. Each tube or a respective tube 210 may be an air tube. As described, the second cladding region 204 may provide a plurality of cladding holes or voids, e.g., air holes.

In the context of various embodiments, each tube or a respective tube 210 may be of any shape and/or size (or cross-section dimension or diameter). As a non-limiting example, each tube or a respective tube 210 may have a circular cross-sectional shape. However, it should be appreciated that other shapes may be possible, including but not limited to, ellipse, square or rectangle. It should be appreciated that the plurality of tubes 210 may have the same or different shapes and/or sizes.

In the context of various embodiments, the plurality of rods 214 may have the same or different shapes and/or sizes as compared to the plurality of tubes 210.

In the context of various embodiments, the core region 202 may be of any shape and/or size (or cross-section dimension or diameter), which may be determined, at least in part, by the arrangement or configuration of the first cladding region 206 and/or the second cladding region 204. As a non-limiting example, the core region 202 may have a circular cross-sectional shape. However, it should be appreciated that other shapes may be possible, including but not limited to, ellipse, square or rectangle.

In various embodiments, the plurality of splits 212 may extend through the second cladding region 204 entirely in a direction from the core region 202 to the first cladding region 206. This may mean that a respective split of the plurality of splits 212 may extend through the second cladding region 204 entirely in a respective direction or along a respective axis from the core region 202 to the first cladding region 206. Respective axes may be different to one another. As a result, a split (capillary) cladding structure may be provided.

In various embodiments, the plurality of splits 212 may extend through the second cladding region 204 entirely in a radial direction extending from the core region 202. In this way, the plurality of splits 212 may extend through the entire width of the second cladding region 204 defined in the radial direction. All of the plurality of splits 212 may extend through the entire width of the second cladding region 204. As may be appreciated, the radial direction may be defined as the direction originating from the central point or axis of the fiber preform 200 and extending outwardly towards a boundary (or perimeter) of the fiber preform 200.

In various embodiments, a respective split of the plurality of splits 212 may be defined between (respective) adjacent (or neighbouring) one or more tubes of the plurality of tubes 210. As a result, a split (capillary) cladding structure may be provided, where a group of one or more tubes 210 may be spaced apart from an adjacent group of one or more tubes 210. Each group of one or more tubes 210 may be defined as a (capillary) cladding unit. As such, the second cladding region 204 may include a plurality of cladding units (of one or more tubes) that may be entirely spaced apart from each other, with splits 212 in between. All of the plurality of splits 212 may extend between (respective) adjacent cladding units through the second cladding region 204 entirely in the direction as defined above.

In various embodiments, a respective split of the plurality of splits 212 may be defined between (respective) adjacent (or neighbouring) single tubes of the plurality of tubes 210.

In various embodiments, a respective split of the plurality of splits 212 may be defined between (respective) adjacent (or neighbouring) two or more tubes of the plurality of tubes 210.

In various embodiments, the plurality of tubes 210 may be arranged in a plurality of layers surrounding the core region 202. Each layer may be in the form of a ring around the core region 202. The plurality of layers of tubes 210 may include two, three or any higher number of layers or rings. The plurality of layers of tubes 210 may be arranged one after the other in the radial direction. The width or thickness of each layer of tubes 210 may be along the radial direction. The plurality of layers of tubes 210 may be concentric layers. It should be appreciated that, instead of at least two capillary cladding layers or rings, in some embodiments, there may be a single capillary cladding layer.

As a non-limiting example, where there is a single layer of tubes 210, each cladding unit may include a single tube 210. Where there are two layers of tubes 210, each cladding unit may include three tubes 210, for example, arranged in a triangular shape. Where there are three layers of tubes 210, each cladding unit may include six tubes 210, for example, arranged in a triangular shape.

In various embodiments, the plurality of rods 214 may be arranged in a plurality of layers surrounding the core region 202. All layers of the rods 214 may entirely surround the core region 202. Each layer may be in the form of a ring around the core region 202. The plurality of layers of rods 214 may include two, three or any higher number of layers or rings. The plurality of layers of rods 214 may be arranged one after the other in the radial direction. The width or thickness of each layer of rods 214 may be along the radial direction. The plurality of layers of rods 214 may be concentric layers. It should be appreciated that, instead of at least two rod cladding layers or rings, in some embodiments, there may be a single rod cladding layer.

In the context of various embodiments, the fiber preform 200 refers to the material from which an optical fiber may be derived or drawn. This may mean that the fiber preform 200 may refer to the initial material as stacked (e.g., a primary fiber preform), or may refer to a cane (e.g., a secondary fiber preform), which is a smaller or thinner version drawn from the primary fiber preform.

FIG. 2B shows a schematic cross-sectional view of an optical fiber 250, according to various embodiments. The optical fiber 250 may be obtainable or obtained by drawing of the fiber preform 200 into the optical fiber 250. This may mean that the optical fiber 250 is substantially similar or identical to the configuration or arrangement of the fiber preform 200 except for the smaller dimension or size. In details, the optical fiber includes a core region, and a cladding arrangement including a first cladding region including a plurality of rods entirely surrounding the core region, and a second cladding region in between the core region and the first cladding region, the second cladding region including a plurality of tubes, wherein a plurality of splits are defined in the second cladding region. It should be appreciated that descriptions in the context of the fiber preform 200 may correspondingly be applicable in relation to the optical fiber 250.

FIG. 2C shows a flow chart 220 illustrating a method for forming a fiber preform, according to various embodiments.

At 222, a plurality of rods are arranged (or stacked) to entirely surround a core region of the fiber preform, the plurality of rods defining a first cladding region of the fiber preform.

At 224, a plurality of tubes are arranged (or stacked) in between the core region and the first cladding region, the plurality of tubes defining a second cladding region of the fiber preform, wherein a plurality of splits are defined in the second cladding region.

The first cladding region and the second cladding region may define or form part of a cladding arrangement around the core region.

In various embodiments, the first cladding region and the second cladding region may be jacketed with or enclosed within an overcladding.

In various embodiments, the plurality of splits may extend through the second cladding region entirely in a direction from the core region to the first cladding region. The direction may be a radial direction extending from the core region.

In various embodiments, a respective split of the plurality of splits may be defined between adjacent single tubes of the plurality of tubes.

In various embodiments, a respective split of the plurality of splits may be defined between adjacent two or more tubes of the plurality of tubes.

In various embodiments, at 224, the plurality of tubes may be arranged (or stacked) in a plurality of layers surrounding the core region.

In various embodiments, at 222, the plurality of rods may be arranged (or stacked) in a plurality of layers surrounding the core region.

It should be appreciated that descriptions in the context of the fiber preform 200 may correspondingly be applicable in relation to the method for forming a fiber preform described in the context of the flow chart 220.

FIG. 2D shows a flow chart illustrating a method for forming an optical fiber, according to various embodiments. At 228, a fiber preform as described herein is drawn into an optical fiber.

In various embodiments, the plurality of tubes (of the fiber preform) may be sealed prior to drawing the fiber preform into the optical fiber. This may mean that open ends of the tubes may be sealed or blocked.

In various embodiments, the plurality of splits and interstitial spaces between the plurality of tubes (of the fiber preform) may be sealed (or blocked) prior to drawing the fiber preform into the optical fiber.

In the context of various embodiments, sealing may be carried out by application of a sealant, e.g., a UV (ultraviolet) glue.

In various embodiments, the core region of the fiber preform is not sealed or blocked.

In various embodiments, a (gas) pressure difference between the core region and the second cladding region may be varied or changed. This may be done prior to the drawing process and/or during the drawing process.

In the context of various embodiments, as described, starting from the fiber preform, the optical fiber may be obtained via a stack-and-draw method.

While the methods described above are illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

The fabrication technique of various embodiments may be based on the stack and draw method, as will be further described below. In this technique, the (fiber) preform may be stacked by hundreds of small capillaries and rods. The structure of the preform may influence the structure of the final fiber. Usually, the outer diameter of the (primary) preform is from about 10 mm to about 25 mm.

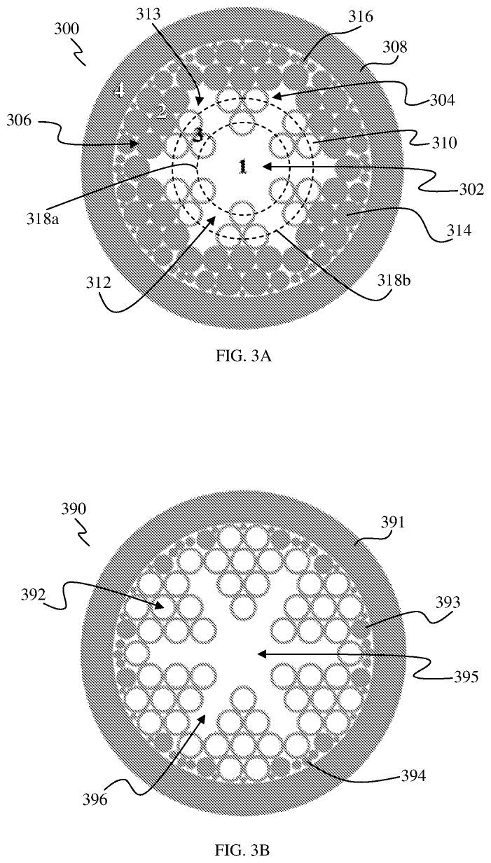

FIGS. 3A and 3B show schematic cross-sectional views respectively of a preform 300 according to various embodiments and a preform 390 of a comparative example.

The preform 300 may include an overcladding 308, within which are arranged a plurality of diferently-sized rods 314, 316 defining a cladding region (e.g., a first cladding region) 306 and a plurality of tubes 310 defining another cladding region (e.g., a second cladding region) 304, where both cladding regions 304, 306 surround a core region 302. The plurality of rods 314, 316 entirely surround the core region 302.

The tubes 310 may be arranged in two layers or rings around the core region 302. For example, some tubes 310 may be arranged in a first ring indicated by the dashed circle 318a, while other tubes 310 may be arranged in a second ring indicated by the dashed circle 318b. The rods 314, 316 may be arranged in two layers or rings around the core region 302.

A plurality of splits 312 may be defined through the cladding region 304 entirely in a radial direction of the preform 300 from the core region 302 to the cladding region 306. In other words, the splits 312 may be defined through the entire width of the cladding region 304 defined in the radial direction. Further, the splits 312 may be defined through the plurality of tubes 310 to completely separate or space apart adjacent cladding units (or groups) 313 of three tubes 310.

Referring to FIG. 3B, the preform 390 may include an overcladding 391, within which are arranged a plurality of diferently-sized rods 393, 394 defining a cladding region and a plurality of tubes 392 defining another cladding region, where both cladding regions surround a core region 395. A plurality of splits 396 are defined through the plurality of tubes 392.

One of the differences between preforms 300, 390 is that, in preform 300, the cladding region 306 (or the gap area labelled “2”) between the cladding region 304 (or the cladding labelled “3”) and the overcladding 308 (or jacket tube labelled “4”) is filled with solid rods 314, 316, while in preform 390, the corresponding cladding region (or gap area) is filled with hollow capillaries. Preform 300 is superior to preform 390 because the solid rods 314, 316 suffer minimal or no deformation caused by gas pressure difference that may occur during a fiber drawing process. As a result, during the drawing process, the core area 302 (labelled “1”) may maintain a substantially uniform size.

Once a preform has been stacked and prepared (e.g., the preform 300 having the structure as stacked as shown in FIG. 3A), the preform may then be drawn into one or more thinner or narrower structures, which are known as “canes” (e.g., secondary preforms). The outer diameter of each cane may generally be between about 2 mm and about 4 mm.

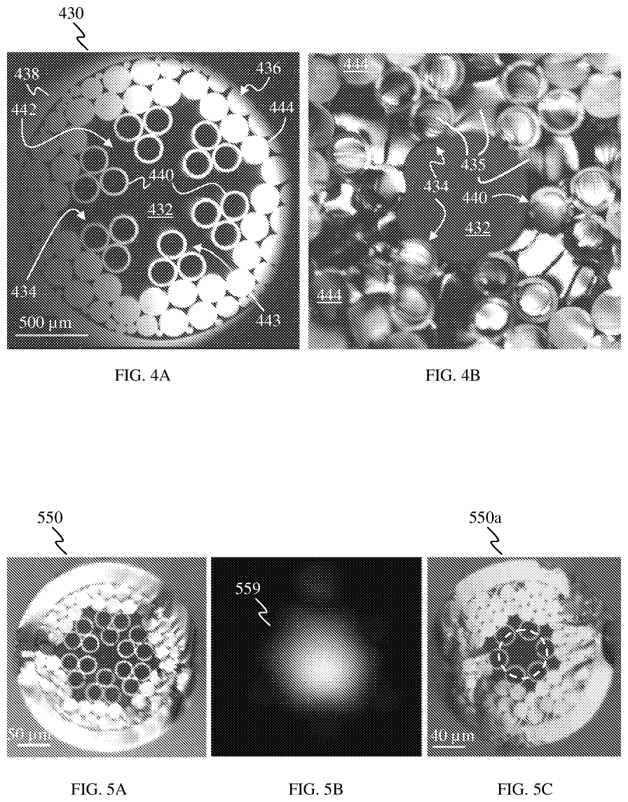

FIG. 4A shows the cross-sectional view of a fabricated cane 430 observed under a scanning electron microscope (SEM). The cane 430 includes a core 432, an inner cladding 434 of capillaries 440 with a split structure (where the cladding 434 may include a plurality of cladding units 443 of capillaries 440 with a split or separation 442 between the cladding units 443), an outer cladding 436 of rods 444, and an overcladding 438. As may be observed, the structure of the cane 430 is substantially uniform. This may be due, at least in part, to the preform structure as illustrated in FIG. 3A.

During the fiber drawing stage, where the cane 430 is drawn into a fiber, a gas pressure difference between the core area 432 and the capillary cladding 434 may be required in order to maintain the structure; otherwise the capillary cladding 434 or the capillaries 440 may shrink due to surface tension. For this purpose, the capillaries 440 may be sealed or blocked using a UV glue 435 while keeping the core area 432 free or unblocked, as shown in FIG. 4B. This may mean that the UV glue 435 may be applied in the space or hole within each capillary 440 as well as the interstitial spaces between capillaries, including the areas where splits 442 occur in the cladding 434. As a result, when vacuum is applied to the core area 432, there exists a positive pressure difference between the capillary “holes” and the core area 432, which may help to maintain the structure. By increasing the pressure difference, the split 442 in the cladding 434 or the separation 442 between the cladding units (or parts) 443 may become smaller. The small separation 442 between the cladding units 443 may be desirable in order to reduce transmission loss. It should be appreciated that the UV glue 435 is applied at the end of the cane 430 which is not drawn into the fiber, and, therefore, thereafter, it may not be necessary to remove the UV glue 435.

In greater details, the process for forming an optical fiber may involve preform fabrication, a cane drawing process, and a fiber drawing process.

Preform Fabrication Process

The entire preform fabrication process may be divided into three steps as described below by way of non-limiting examples.

Preparation of capillaries and rods: Capillaries and rods may have a diameter in the range of about 0.3-3 mm and a length of about 1 m. They may be drawn from tubes/rods with a larger size (e.g., 10-40 mm) by using an optical fiber drawing tower. For rod drawing, the size may be controlled by setting the ratio between the drawing speed and the feed speed. For capillary drawing, the air filling ratio may be taken into consideration. By controlling the drawing temperature and the inner tube gas pressure, the air fill fraction (area of air over area of the capillary) may be controlled, and, hence, the capillary thickness. The wall thickness of these capillaries may be suitably tailored as the transmission window of the fiber may be narrow in the case of thick capillary walls while capillaries with a thin glass wall may be fragile and too sensitive to gas pressure difference; the ratio of the inner capillary diameter over the outer capillary diameter may be in the range of about 0.8-0.95.

Capillary/rod stacking: Capillaries may be stacked using a preform stacking rig that has been designed and built in-house. Apart from manually loading the capillaries into the hook of the rig, the rig may be capable of automatically stacking the capillaries based on user instructions. Therefore, the rig may semi-automatically stack the capillaries, due to the need for manual work in one part of the process. An operation panel or user interface for the rig is provided to control the rig. The movement of the motor of the rig may be controlled to adjust automatically according to the capillary diameter so that the capillary may be aligned to the correct position. By using the operation panel, each capillary may be released to drop onto the target position, and then the motor may go to the next position automatically. It may take about 1 hour to stack a preform with 150 capillaries.

Post processing of stacked array: The stacked array, as directly stacked by the stacking rig, may have an outer shape or boundary of a hexagon. Some capillaries may then be removed so as to re-shape the outer shape of the stacked array to be as close to a circle as possible. The stacked capillary array may then be inserted into a jacket tube which may have a circular shape. The gap area between the array and the jacket tube may be small and the capillaries may not slip off. To make it more stable, rods with smaller sizes may be used to fill and minimize the gap area, and, thus, a “preform” with a round shape may be fabricated.

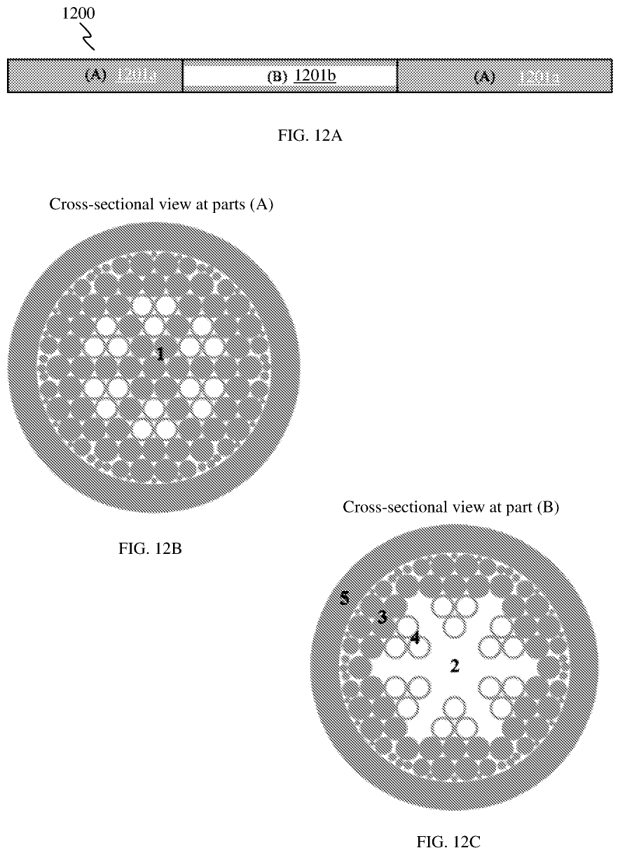

Stacking of rods may be carried out with the stacking of capillaries and/or during post processing to form the preform. FIG. 12A shows a schematic side view of a preform structure 1200, according to various embodiments, while FIGS. 12B and 12C show schematic cross-sectional views respectively of parts (A) 1201a and part (B) 1201b of the preform 1200. Parts (A) 1201a are provided to support part (B) 1201b, where part (B) 1201b is the useful part of the preform 1200 and which is to be drawn into a fiber. As a non-limiting example, the outer diameter of the preform 1200 may be from about 10 mm to about 25 mm. Referring to FIG. 12B, the central area (labelled “1”) is made to be solid to support the hollow (core) area (labelled “2”) in part (B) 1201b (see FIG. 12C). Referring to FIG. 12C, the portion labelled “2” is the central (core) hollow region, the portion labeled “4” is the split cladding region formed by capillaries, the portion labelled “5” is the jacket tube, and the portion labelled “3” is the rod (cladding) region used to fill in the gaps between the jacket tube “5” and the cladding “4”.

Cane Drawing Process

The drawing process of fibers with micro structures may be separated into two steps in order not to deform the micro structures. At first, several canes with a size in the range of about 2.0-4 0 mm may be drawn from a preform, and, then, these canes may be used for drawing fibers with several hundred microns diameter. As a result, the drawing down ratio at each step may be around 10.

The end of the preform for cane drawing may be fused to collapse while one side of the preform has a small gap prepared by a glass cutting saw. During the cane drawing process, the gas inside the hollow core area may escape through the crack/gap because there are inter-spaces between the capillaries while the gas inside the capillaries may be unable to escape since the end of the preform has been fused. This leads to a positive differential pressure between the cladding and the core area and the positive differential pressure may make it possible not just to counterbalance the effect of surface tension but also to achieve substantial expansion of the holey region, which may be helpful to reduce the fiber core size and minimise or avoid the shrinking of capillaries.

The preform may be controlled by a precision feed machine and may be fed into a a circular heater called the drawing furnace. Inside the drawing furnace, the preform end may be heated and softened to the point where it may be drawn into a thinner preform, which is known as a “cane”. To draw the cane with desired geometry parameters, preform feed speed, cane drawing speed, furnace temperature and cane puller tension may be controlled. The furnace temperature and the feed speed may influence the softness of the preform and hence influence the tension and change the sensitivity to gas pressure differential. Increasing the temperature and/or slowing down the feed speed may increase the softness of the preform. As a non-limiting example, canes of a diameter around 2.5 mm may be drawn.

Fiber Drawing Process

Using the cane 430 (FIG. 4A) as a non-limiting example, there are a lot of hollow areas which may make the whole structure sensitive to gas pressure. Such a cane may be preprocessed before drawing into the fiber. As described above, during the fiber drawing stage, a gas pressure difference between the core area and the cladding capillaries may be required to maintain the structure, and the capillaries may be sealed or blocked using a UV glue while keeping the core area free or unblocked (for example, see FIG. 4B). As a result, when vacuum is applied to the core area, there exists a positive pressure difference between the capillary “holes” and the core area, which may help to maintain the structure. By increasing the pressure difference, the separation between the cladding units (or parts) may become smaller. The small separation between the cladding units may be desirable in order to reduce transmission loss. The cane may now be ready for fiber drawing.

The fiber drawing setup may include functionally different devices and instruments such as a precision feed motor, a high temperature furnace, a fiber thickness monitor, a gas pressure controlling system, a coating applicator together with a coating bath, a UV curing lamp, a draw tension gauge, a drawing capstan and a take-up bobbin in a 10-meter-high mechanically stable tower. There may be a number of processes involved in fiber drawing, and may be classified into five major zones, which may include a gas zone, a heating zone, an aligning zone, a coating zone, and a collecting zone.

The gas zone may include three gas channels. One of the gas channels may be used to control the cane gas pressure with argon (Ar). Users may manually set the volume of gas (cc/min), and by controlling the leakage valve in the pipeline, the pressure in the cane may be controlled accordingly. As many reactions may occur at high temperature, another argon channel may be connected to the fiber drawing furnace to purge the furnace and keep it clean. A gas channel supplying nitrogen (N₂) may be connected to the coating die to push the coating out. There may also be a compressed air channel used to drive the tension gauge.

The heating zone may include a high temperature furnace (e.g., maximum value may be about 2500° C.) and a precision temperature controller with a resolution which may be as precise as 0.5° C. The (drop down) temperature set to soften the solid preform to form a drop down shape may be about 2100° C. (and about 2060° C. for a tube). The process temperature (a temperature under which the fiber may be stably drawn with proper tension) may be a bit lower than the drop down temperature. From a drop down position, the preform may be tapered to a smaller size, and a bare glass fiber may be continuously drawn down. It may take about 20 minutes for the furnace to warm up from room temperature to the drop down temperature.

In the aligning zone, there may be a thickness monitor. In addition to measuring the size of the drawn fiber, it may also be used to monitor whether the fiber may be at the center of both the furnace (in the heating zone) and the coating applicator (in the coating zone to be described below), as, otherwise, there may be challenges involving uneven heating and/or uneven coating. If the fiber is not at the center, it may be adjusted with one or more motors in the horizontal plane.

The coating zone may be used to jacket the bare glass fiber with soft coating materials. Although the pristine glass fiber may have a very high strength, e.g., around 70,000 kg/cm², it may be easily broken due to surface damage when a bare fiber comes in contact with other objects. Hence, surrounding the bare glass fiber with a coating material may help to protect its outer surface. There are generally two kinds of coatings—low index coating and high index coating. The coatings may be stored in a warm coating bath (above 30° C.) in order to increase the fluidity. As described earlier, nitrogen may be used to apply pressure to push the coating into the coating die. The die radius R_{d} may be selected to determine the coated fiber radius R. The relationship of the die radius R_{d}, the coated fiber radius R, and the bare fiber radius r may be defined by R=(r+R_{d})/2.

The coated fiber may then go through a UV lamp and the coating attached on the fiber may be cured. The collecting zone may include a take-up capstan, a rotational winder with a bobbin and several pulleys. The capstan provides the force to pull down the fiber.

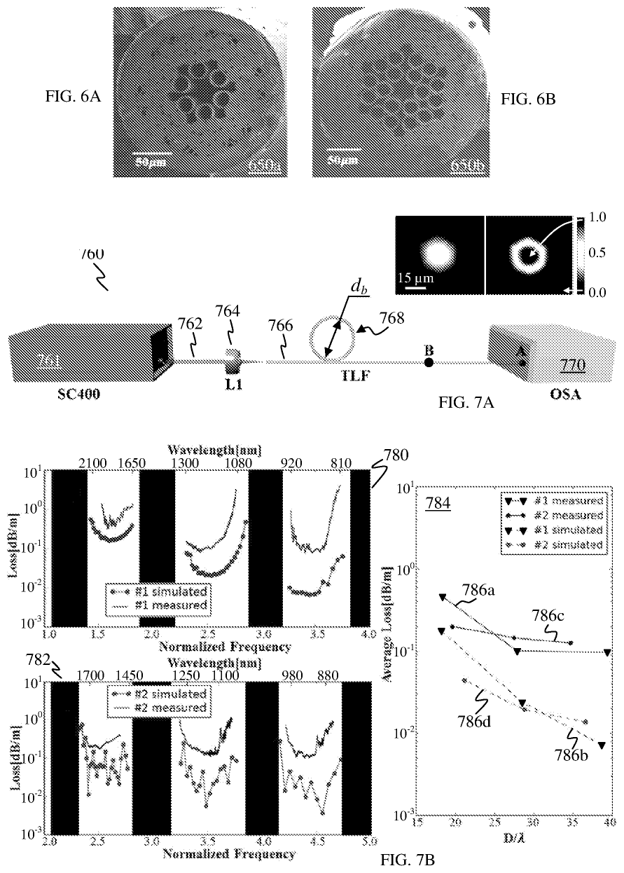

By controlling the differential gas pressure between the core and the cladding, a 2-layer tube lattice fiber (2TLF) with good and symmetric structure may be obtained (see FIG. 6B to be described later below).

FIG. 5A shows a microscopic image of a cross-sectional view of a split cladding fiber (SCF) 550 of various embodiments. As may be observed, the fiber 550 has the expected split cladding structure (similar to that of the cane 430, FIG. 4A), while the separation between the cladding units is sufficiently small. In addition, the fiber 550 has a uniform structure and any deformation is almost negligible or non-observable.

A fiber 550 with a length of about 1 meter may be illuminated by a 1064-nm wavelength light source. The near field image may be monitored by a CCD (charge-coupled device) camera and is shown in FIG. 5B. As may be observed in FIG. 5B, the fiber 550 may be able to support pure single mode transmission (as represented by propagation of light 559) at 1064 nm, which is a wavelength generally employed for commercial lasers. As a non-limiting example, by adjusting the (capillary) wall thickness, such fiber 550 may be able to transmit at a wavelength or a wavelength range from the ultra-violet (UV) to the mid-infra red (mid-IR). Fibers for applications in the short wavelength region (from about 300 nm to about 750 nm) may have a capillary wall thickness in the range of about 0.2 μm to about 0.6 μm, while fibers for applications in the long wavelength region (from about 2 μm to about 6 μm) may have a capillary wall thickness ranging from about 1.4 μm to about 4.3 μm.

A simplified hollow core anti-resonant fiber (SHAF) may be fabricated in the same way following the method of various embodiments. FIG. 5C shows a microscopic image of the fiber 550a fabricated. As shown, the SHAF 550a includes a split cladding structure with a one-ring cladding arrangement (as traced by the dashed circle). As may be observed, the fiber 550a has a substantially uniform structure. Both the fibers 550, 550a have a good and uniform structure and may be made with a similar core size (around 32.0 μm) so as to make a fair loss comparison.

As described, the SCF fabrication method of various embodiments may be able to fabricate long length SCFs with a uniform structure. Various embodiments may include one or more of the following features: (1) being less influenced by variation of the gas pressure difference between the fiber core and the cladding holes, (2) easy to control the gas pressure difference, or (3) may be applied to fabricate different types hollow core fibers (such as SHAFs). Further, various embodiments may include one or more of the following techniques (but not limited to) to achieve the aforementioned feature(s): (i) a two ring structured anti-resonant fiber, where the first ring (proximal to the core) determines the loss level when r/λ is big enough, and the second ring (distal to the core) helps to reduce the transmission loss when r/λ gets smaller, (ii) an air core micro-structured fiber fabrication using rods to stack outer layers to reduce air core size, or (iii) an air core micro-structured fiber fabrication using rods to reduce the complexity of pressure controls during cane and/or fiber drawing.

Non-limiting examples and results will now be described with reference to FIGS. 6 to 12C.

Hollow Core Fiber Fabrication

The fabrication method used is the stack-and-draw method to fabricate the fibers. HSQ 300 tubes (16 mm×20 mm) and HSQ 300 rods (12 mm) from Heraeus may be used. These tubes and rods may then be drawn into smaller capillaries and rods respectively. The drawn capillaries and rods may then be stacked together and jacketed by another HSQ 300 tube to form a preform. Subsequently, the preform may be pulled into air core fibers in-house. The structures of different types of fibers that may be fabricated are shown in FIGS. 6A and 6B, illustrating two types of split cladding fibers (SCFs) or tube lattice fibers (TLFs). A one-layer TLF (1TLF) 650a (denoted as “Fiber #1”) and a two-layer TFL (2TLF) 650b (denoted as “Fiber #2”) may be fabricated for comparison to demonstrate the role of a second cladding layer. The structure uniformity of the fibers 650a, 650b may be maintained by controlling or building precise differential pressure during the fiber drawing process.

The 1TLF (Fiber #1) 650a has about 32.4 μm core diameter, about 20.3 μm capillary hole size (or diameter), about 1.45 μm capillary wall thickness and about 220 μm outer diameter, while the 2TLF (Fiber #2) 650b has about 31.9 μm core diameter, about 20.9 μm capillary hole size (or diameter), about 1.96 μm capillary wall thickness and about 245 μm outer diameter. Both fibers 650a, 650b have substantially good uniform structure within a 5% of variation in core diameters. The two fibers 650a, 650b are made into a similar core size intentionally for a fair loss comparison between the fibers 650a, 650b.

Background Loss Measurement and Suppression of Confinement lLss (CL) in 2TLF

The cutback method may be employed to measure the background loss (or transmission loss) of the fundamental mode (FM) of the hollow core fibers 650a, 650b. FIG. 7A shows the setup 760 that may be used. A supercontinuum laser source (e.g., SC400 from Fianium) may be employed as the light source 761. The light 762 may be coupled into the fiber (TLF 766), e.g., 1TLF 650a or 2TLF 650b, using a microscope objective (L1) 764 (e.g., a plane-convex lens with 25 mm focal length) directed into one end of the fiber 766. The fiber 766 may first be bent into a circle or loop 768 with 15 cm diameter (d_{b}=15 cm) in order to filter out the higher-order modes (HOMs). The other end of the fiber 766 (point A) may be inserted into a bare fiber adapter and connected to an optical spectrum analyzer (OSA) 770 to measure the transmission spectrum. Therefore, one end facet of the fiber 766 is used as the signal input end, and the other facet serves as the signal output end. Using the cutback method, the fiber under test (FUT) (fiber 766) may be successively cut to a shorter length (e.g., cut to point B or any other points on the fiber) for one or more additional transmission spectrum measurements. The deviation or difference between two transmission spectra (at diferent fiber lengths) reveals the attenuation loss of the FUT. As an example, where P_{A} is the power at point A, P_{B} is the power at point B, and l is the cut fiber length between points A and B, the fiber loss may be calculated as (P_{B}−P_{A})/l.

To ensure that the measurement is for the fundamental mode loss, the output light from point B may be directed to a CCD or CMOS (complementary metal-oxide-semiconductor) camera via a 50× microscope objective. In this way, a near field mode image may be monitored from the output facet of the fiber 766 with the camera to monitor the fundamental mode propagation, results of which are shown in the inset of FIG. 7A. Based on the results, a pure fundamental mode (FM) may be observed, where no indication of higher-order modes may be observed, confirming that the fiber bending effectively suppresses the higher-order modes. Thus, the loss measurement only includes a robust FM. Therefore, the FM output power spectrum is collected by the OSA 770.

FIG. 7B shows plots of simulated and measured loss of different fibers of various embodiments, illustrating the simulated confinement loss (CL) and the measured loss of 1TLF (Fiber #1) (see 650a, FIG. 6A) and 2TLF (Fiber #2) (see 650b, FIG. 6B). Plot 780 shows the simulated and measured loss evolution of Fiber #1 over three transmission bands (from 800 nm to 2100 nm) while plot 782 shows the simulated and measured loss curves of Fiber #2 over three transmission bands (from 850 nm to 1750 nm), where the black areas represent the high resonant regions. FIG. 7B further shows a plot 784 of the loss level at different D/λ values, illustrating the average loss taken at different transmission bands over D/λ values. In FIG. 7B, the simulated loss represents the CL only while the measured loss represents the total fiber loss including the CL and the fabrication induced loss.

Referring to plot 780, the loss of the Fiber #1 (i.e., the fiber with the SHAF structure; 1TLF) was measured with 20 m and 3 m fibers (i.e., by cutting a 20.0-m long fiber to a 3.0-m long fiber). The loss of the Fiber #2 (i.e., the fiber with the SCF structure; 2TLF) was measured with 15.3 m and 4.1 m fibers (i.e., by cutting a 15.3-m long fiber to a 4.1-m long fiber). The simulated CL results were obtained using an open source software based on the vector wave expansion method.

The losses are plotted over both the normalized frequency, F (where F=2t\sqrt{n²−1}/λ), and wavelength, λ, where t is the core boundary wall thickness (or capillary wall thickness), and n is the refractive index of the cladding material. When F closes to an integer, there is a high loss region, and a low loss transmission band exists between every adjacent high loss regions. The CL may be determined by a fiber design, but there may be other contributors to the loss introduced during fabrication such as scattering loss and/or imperfection loss induced by structural variation across the fiber cross-section such as uniformity of capillary holes or hole distance.

Fabrication induced losses may reduce with increasing wavelength (thus, decreasing D/λ). Consequently, it is the CL that contributes to the increasing measured loss when the value of D/λ gets smaller towards longer wavelengths. At short wavelength region, the fabrication related losses may contribute more to the evolution of the total fiber loss than the CL. While not wishing to be bound by theory, this may explain the insignificant loss difference between 1TLF and 2TLF at the short wavelength band as shown in FIG. 7B. When the transmission band moves towards longer wavelengths, the CL grows quickly and may become a dominant factor to the total fiber loss. Such tendency is evident in 1TLF (see plot 780), but not in 2TLF (see plot 782) for both simulation and measurement results.

The behaviours of the measured loss and the simulated CL over D/λ are summarised in plot 784, showing the relationship between the D/λ value and the basement loss level of each transmission band. D is equal to 2r where r (=16.05 μm) is the core radius. λ is the central wavelength of each transmission window. The presented loss at each band was obtained by taking an average of the loss curves in plots 780. 782, excluding the sharp rises close to the inhibited regions.

As may be observed in plot 784, the confinement loss increases as D/λ value becomes smaller and may lead to an increase in the total measured loss. When r/λ>12 (or D/λ>24), the fiber with additional cladding layer (i.e., 2TLF, Fiber #2) shows little or no advantage over the simplified one (i.e., 1TLF, Fiber #1). This explains why the SHAF or 1TLF is a popular design and such fibers are made to satisfy r/λ>12. Hence, the performance of the fibers fabricated by the fabrication technique of various embodiments is highly consistent with the simulation result, which confirms the feasibility and the advancement of this fabrication technique that may alleviate fabrication complexity. Further, the fabrication method may realise a small air core without compromising the confinement loss.

Put in another way, as shown in plot 784, the second cladding layer may slow the loss increasing rate over D/λ, making the 2TLF a promising design for applications benefiting from a small D/λ, or a small core. The loss with a smaller D/λ, or at a longer wavelength, is lower in 2TLF.

The quality of TLF for gas-light interaction applications, for example, may be determined by introducing a figure of merit (FOM),

$$e . g . , {f}_{om} = \frac{λ}{π {D}^{2} α} ,$$

where α is the exponential attenuation of propagation light intensity. From the measurement results in plot 784, the FOM of both Fiber #1 and Fiber #2 is around 2500 when D/λ=27. However, as the value of D/λ decreases to 20, the FOM of Fiber #2 maintains the same, whereas that of the Fiber #1 decreases to 1240. Due to the lower attenuation at the long wavelength band as well as the small core, the 2TLF may offer better performance in gas-light interaction applications.

Demonstration of Relationship Between Capillary Hole Size and Bending Loss

The bending loss of 1TLF may be influenced by cladding hole size, where a small hole size may suppress the bending loss at a given core size. The smaller tube hole size may reduce an effective refractive index of a cladding airy mode, which may render coupling between the core and cladding modes weaker, even in a bent fiber. Bending losses in 2TLFs with various hole sizes were measured to determine the relationship.

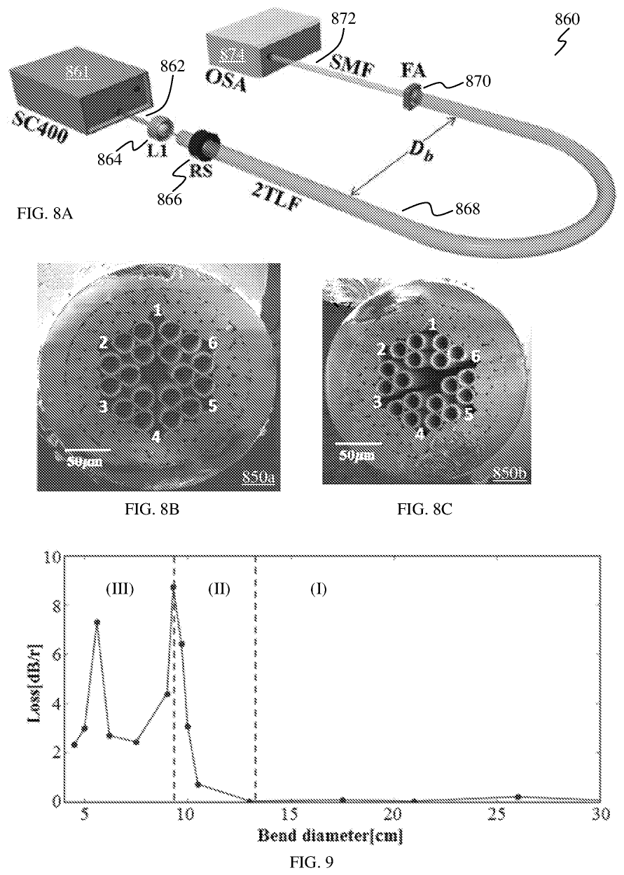

FIG. 8A shows a schematic view of the setup 860 used to measure bending loss. A (fiber laser pumped) supercontinuum laser source (e.g., SC400 from Fianium) may be employed as the light source 861. The light or laser beam 862 may be coupled into the fiber under test (FUT) (illustrated as 2TLF in FIG. 8A) 868 using a microscope objective (L1) 864 (e.g., a plane-convex lens) directed into one end of the fiber 868. The FUT 868 may be bent to a half circle with diameter D_{b}. As a result of the bending, only the core mode may be guided. After propagating through the bent fiber 868, the laser beam (i.e., the core mode) may be coupled into a single mode fiber (SMF) 872 via a bare fiber adapter (FA) 870. The SMF 872 may be connected to an optical spectrum analyzer (OSA) 874 to measure or record the transmission spectrum. Such a method is generally used to determine bending losses of hollow core fibers.

As bending loss may be subject to the bending direction in the fiber, such as a 2TLF, and, in order to control the bending direction of the fiber, the FUT 868 may be mounted on a rotational stage (RS) 866 in order to align the bending direction to the split gap. The end facet of the fiber may be monitored using a CMOS camera to determine the bending direction along a cladding gap. When the fiber 868 is revolved on the rotational stage, the bending direction changes accordingly. To ensure the fiber is not twisted, the fiber end is not bounded when rotated.

FIGS. 8B and 8C show scanning electron microscopic images of cross-sectional views of split cladding fibers (SCFs) of various embodiments, illustrating the 2TLFs that may be used for bending loss measurements. The 2TLF (denoted as “Fiber #3”) 850a has a core diameter, D=32.0 μm, a capillary hole diameter d=19.7 μm, and d/D=0.62, while the 2TLF (denoted as “Fiber #4”) 850b has a core diameter, D=32.3 μm, a capillary hole diameter d=16.0 μm, and d/D=0.50. Gaps or splits in the cladding area are denoted with numbers “1” to “6”.

Fiber #3 850a and Fiber #4 850b have substantially similar core size, D, of about 32 μm, but with different capillary hole diameters, and, thus, their respective d/D parameter is determined by d only. The capillary wall thickness of both fibers 850a, 850b is the same at about 2.0 μm. The two fibers 850a, 850b are experimentally characterized with a similar background loss of around 0.2 dB/km at about 1200 nm because of the similarity in the core size and the capillary wall thickness.

The evolution trend in the bending loss of Fiber #3 850a is shown in FIG. 9 when the fiber bending direction is aligned to a split gap. The bending loss curve is divided into three parts according to the evolution trend. When the bending diameter is large (region I), the bending loss is too low to be accurately measured. When the bending diameter enters region II, its bending loss grows sufficiently to be detected by the OSA. As shown in FIG. 9, an exponential increase of the bending loss with tighter bending may be observed in this region. As the bending diameter is further reduced (region III), the behavior dramatically changes. Instead of an exponential growth, the bending loss oscillates in an irregular manner. Such a behavior was predicted in simulation (results not shown) with an explanation of the bending dependence of the Fano resonances, and the results in FIG. 9 confirms the theoretical results. It is also found that a similar behavior may be observed regardless of the bending direction to different split gaps. Measurements may be carried out in Regions I and II only in order to obtain results of the bending loss dependence on the hole size. To evaluate the bending loss, a 3-dB diameter may be introduced, i.e., a bending diameter at which a bending loss becomes 3-dB/round. Thus, the smaller the 3-dB diameter, the lower the bending loss.

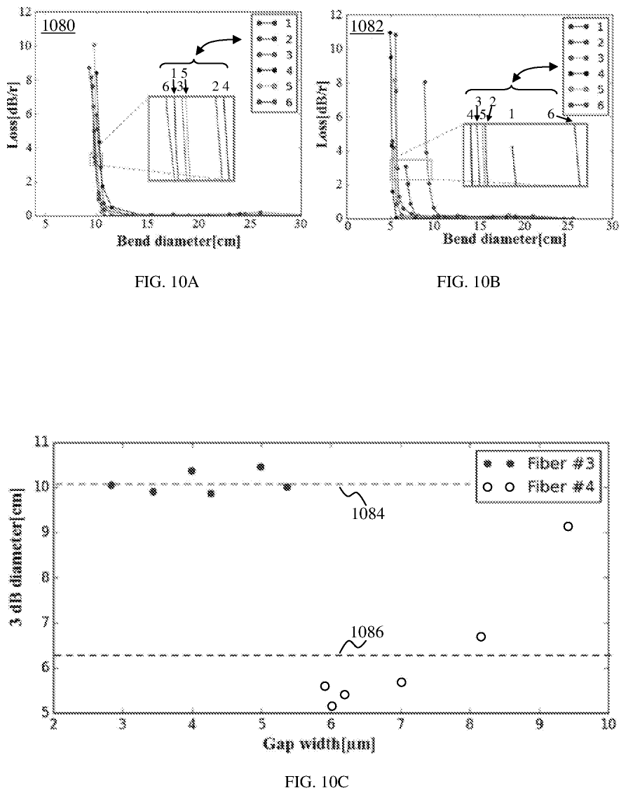

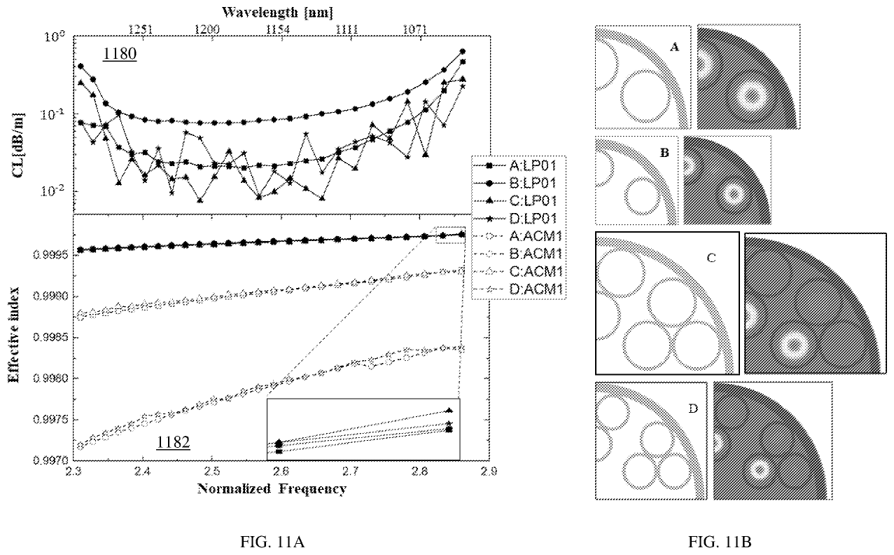

FIGS. 10A and 10B show plots of measured bending losses for the fibers of FIGS. 8B and 8C respectively at different bending directions, illustrating the bending loss of Fiber #3 in plot 1080 and Fiber #4 in plot 1082 at 1200 nm (corresponding to a normalized frequency F=3.5, the normalized frequency calculated from F=2t√(n²−I)/λ, where t is the capillary wall thickness, λ is wavelength, and n=1.45 is the refractive index of the cladding material silica) when bent to different directions. The tested fibers were bent to different split gaps as labeled from “1” to “6” in anti-clockwise direction (see FIGS. 8B and 8C). The bending performances are summarized in FIG. 10C. The average 3-dB bending diameter for Fiber #3 (d/D=0.62) is measured to be 10.1 cm (represented by dashed line 1084), which is approximately 60% larger than that for Fiber #4 (d/D=0.50) whose 3-dB bending diameter is averaged to be 6.3 cm (represented by dashed line 1086). Since the two fibers have a substantially similar core size (around 32.0 μm), and, consequently, the same loss around 0.2 dB/m at 1200 nm, the only variable in dID becomes the hole size, d. The capillary hole size for Fiber #3 and Fiber #4 are measured as 19.7 μm and 16.0 μm respectively. Therefore, the results clearly demonstrate that the fiber with a smaller hole diameter (Fiber #4) has a lower bending loss.

Compared to Fiber #3 (see plot 1080, FIG. 10A), the bending direction dependence is more significant in Fiber #4 (see plot 1082, FIG. 10B). This may be caused by asymmetric nature of the fiber structure. While the split gaps may (only) be varied within about 2.0 μm in Fiber #3, the gap size in Fiber #4 exhibits a wider variation of about 4.0 μm. As a consequence, the bending loss in Fiber #4 may become subjective to the bending directions. Bending to a wider gap may cause a larger bending loss as shown in FIG. 10C for Fiber #4. The results suggest that a wider gap may bridge the mode index difference between the core and the cladding modes and may increase the bending loss.

Low Bending Loss and Low Transmission Loss

The transmission performance of a TLF is generally determined by the core size (to determine the CL) and the capillary wall thickness (to determine the transmission band), while the bending loss is controllable by the hole size. Hence, the characteristics of a TLF may be tailored by adjusting the independent design parameters towards bending insensitive low loss design. In the 1TLF design, however, there is a trade off between low bending loss and low transmission loss. A smaller cladding hole size is desirable to achieve a low bending loss. However, the small cladding hole may effectively reduce the distance between the core and the fiber jacket tube, which may result in a leakage loss increase. The 2TLF structure may, however, not be bound by this trade-off. The second cladding layer keeps the distance sufficiently large to minimise or avoid excess leakage loss without sacrificing the capillary hole size, hence providing a better bending performance This effect of the 2TLFs may be as shown in FIGS. 11A and 11B. Four fiber designs with various hole sizes are theoretically compared.

FIG. 11A shows a plot 1180 of simulated confinement loss of the fundamental mode, and a plot 1182 of simulated refractive index of the fundamental mode and the airy cladding mode corresponding to the fiber structures are shown in FIG. 11B. The first two structures—structures “A” and “B”—represent 1TLFs, and the others—structures “C” and “D”—represent 2TLFs. All the structures “A”, “B”, “C”, and “D” as shown in FIG. 11B have substantially the same core size of about 32.0 μm and substantially the same wall thickness of about 1.43 μm, so as to allow a fair comparison of the structures. The only difference between the structure “A” and “B”, and the structures “C” and “D” is the capillary hole diameter. The hole diameter of the cladding capillaries in the structures “A” and “C” is about 20.0 μm while that in the structures “B” and “D” is about 13.14 μm.

Plot 1182 illustrates the effective index of the airy cladding mode in the first cladding ring (ACM1). The airy cladding mode inside the first cladding ring has the closest effective index to the core modes and the beam profiles of the ACM1 are shown on the right side images of FIG. 11B. The index gap between the ACM1 and the core mode may represent the coupling strength, hence, the transmission loss. The core mode effective index is substantially the same for all the fibers because of the same core diameter. In addition, the effective refractive index of ACM1 in structures “A” and “C” are much larger than that in the structures “B” and “D” as shown in plot 1182. Consequently, the coupling between the core modes and the ACM1 in the structure “A” and “C” may be stronger. Without wishing to be bound by theory, this may explain the reason that shrinking or reducing the cladding capillary hole may reduce the bending loss.

Subsequently, it may be expected that both the structure “B” and “D” may have a lower bending loss than fibers “A” and “C”, respectively, due to the smaller hole size. However, plot 1180 shows that the confinement loss (CL) of the structure “B” is much higher than that of the structure “A”. This high CL may account for the close proximity of the core to the jacket tube. In 1TLF, the attained low bending loss from the small hole size may be compensated by the high CL. However, 2TLF is free from this constraint as indicated in plot 1180. The second (cladding) layer may provide a sufficient distance between the core modes and the fiber jacket to minimise or prevent undesired leakage. Hence, a 2TLF may provide a highly engineerable platform, with freely adjustable individual design parameters of one or more of D, t and d without trade-offs. Further, the bending loss of a 2TLF may not be higher than their 1TLF counterpart because adding the second cladding layer generally may not increase the bending loss.

As described above, contradicting requirements in a TLF design may lead to compromises in anti-resonant fiber performances. The design parameters including the core size, capillary wall thickness and capillary hole size may be interlinked, potentially leading to trade-offs in fiber characteristics. Adding a second cladding layer to the TLF may address or resolve the contradicting requirements and may allow individual control of the parameters.

Theoretical and measurement results provided herein show the effects of 2TLF for a small core low loss anti-resonant fiber that may be promising for various applications, including applications of gas-light interaction and mid-infrared transmission. Further, bending loss dependence on the capillary hole size is experimentally demonstrated. The ability of 2TLF to achieve low bending loss without sacrificing the confinement loss by the fulfilling small capillary hole size requirement as well as the separation of the core and the jacketing tube is also shown. Hence, the second cladding layer may potentially lead to advances in anti-resonant fiber technology by allowing independent control of one or more design parameters to fulfill the design purposes without any compromise or trade-off.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A fiber preform or an optical fiber comprising:
a core region; and
a cladding arrangement comprising:
a first cladding region comprising a plurality of rods entirely surrounding the core region, and
a second cladding region in between the core region and the first cladding region, the second cladding region comprising a plurality of tubes, wherein a plurality of splits are defined in the second cladding region.

2. The fiber preform or the optical fiber as claimed in claim 1, wherein the plurality of splits extend through the second cladding region entirely in a direction from the core region to the first cladding region.

3. The fiber preform or the optical fiber as claimed in claim 2, wherein the direction is a radial direction extending from the core region.

4. The fiber preform or the optical fiber as claimed in claim 1, wherein a respective split of the plurality of splits is defined between adjacent single tubes of the plurality of tubes.

5. The fiber preform or the optical fiber as claimed in claim 1, wherein a respective split of the plurality of splits is defined between adjacent two or more tubes of the plurality of tubes.

6. The fiber preform or the optical fiber as claimed in claim 1, wherein the plurality of tubes are arranged in a plurality of layers surrounding the core region.

7. The fiber preform or the optical fiber as claimed in claim 1, wherein the plurality of rods are arranged in a plurality of layers surrounding the core region.

8. A method for forming a fiber preform, the method comprising:
arranging a plurality of rods to entirely surround a core region of the fiber preform, the plurality of rods defining a first cladding region of the fiber preform; and
arranging a plurality of tubes in between the core region and the first cladding region, the plurality of tubes defining a second cladding region of the fiber preform, wherein a plurality of splits are defined in the second cladding region.

9. The method as claimed in claim 8, further comprising jacketing the first cladding region and the second cladding region with an overcladding.

10. The method as claimed in claim 8, wherein the plurality of splits extend through the second cladding region entirely in a direction from the core region to the first cladding region.

11. The method as claimed in claim 10, wherein the direction is a radial direction extending from the core region.

12. The method as claimed in claim 8, wherein a respective split of the plurality of splits is defined between adjacent single tubes of the plurality of tubes.

13. The method as claimed in claim 8, wherein a respective split of the plurality of splits is defined between adjacent two or more tubes of the plurality of tubes.

14. The method as claimed in claim 8, wherein arranging a plurality of tubes comprises arranging the plurality of tubes in a plurality of layers surrounding the core region.

15. The method as claimed in claim 8, wherein arranging a plurality of rods comprises arranging the plurality of rods in a plurality of layers surrounding the core region.

16. A method for forming an optical fiber, the method comprising drawing a fiber preform into the optical fiber,
wherein the fiber preform comprises:
a core region; and
a cladding arrangement comprising:
a first cladding region comprising a plurality of rods entirely surrounding the core region, and
a second cladding region in between the core region and the first cladding region, the second cladding region comprising a plurality of tubes, wherein a plurality of splits are defined in the second cladding region.

17. The method as claimed in claim 16, further comprising sealing the plurality of tubes prior to drawing the fiber preform into the optical fiber.

18. The method as claimed in claim 16, further comprising sealing the plurality of splits and interstitial spaces between the plurality of tubes prior to drawing the fiber preform into the optical fiber.

19. The method as claimed in claim 16, further comprising varying a pressure difference between the core region and the second cladding region.
